(19) United States
(12) Patent Application Publication
(10) Pub. No.: US 2005/0211699 A1
(43) Pub. Date: Sep. 29, 2005

(54) Flexible electrically switchable glazing structure and methods of forming same

(76) Inventors: Sadeq Faris, Pleasantville, NY (US); Yingqiu Jiang, Sunnyvale, CA (US); Wenhua Niu, San Diego, CA (US)

Correspondence Address: REVEO, INC., 3 WESTCHESTER PLAZA, ELMSFORD, NY, 10523, US

(21) Appl. No.: 10/523,494

(22) PCT Filed: Aug. 4, 2003
(86) PCT No.: PCT/US03/24515

§ 371 Date: Jun. 1, 2005

(30) Foreign Application Priority Data
Aug. 2, 2002 (US) 60400762

(51) Int. Cl. H05B 3/06

(52) U.S. Cl. 219/522; 219/536

(57) ABSTRACT

Flexible electrically switchable panels or glazing structures and methods of manufacturing such flexible electrically switchable panels or glazing structures are provided. Particularly, methods and processes are disclosed that enable fast and efficient cutting and shaping of flexible glazing structures into any desired shape and size. In certain embodiments, methods and processes are disclosed whereby barrier lines are formed to define regular or irregular cutting lines and seals. In further embodiments, methods and processes are disclosed whereby notches are defined to expose upper and lower substrate conductive surfaces. In still further embodiments, methods and processes are disclosed whereby glazing structures of irregular shapes and sizes are formed.

### FIELD OF THE INVENTION

The herein invention is related to flexible electrically switchable panels or glazing structures and methods of manufacturing such flexible electrically switchable panels or glazing structures.

### BACKGROUND OF THE INVENTION

Great efforts have been made to optimize the manner in which one can control electromagnetic radiation passing through a window, e.g., in residences, commercial buildings, automobiles, etc. Such control may be to provide privacy, reduce glare from ambient sunlight, or to control harmful effects of ultraviolet light. Technology associated with such light control has evolved significantly over the conventional window shade or blind.

One approach to electromagnetic radiation control uses passive films, such as high reflectivity films, heat saving films, and fade-protection films. However, such films generally result in a constant reduction in interior light and loss in visibility. Another approach uses glass panels having radiation transmission characteristics that absorb infrared and ultraviolet wavelengths, while transmitting visible wavelengths.

Further approaches to electromagnetic radiation control use “smart window” technology, wherein light transmission characteristics may be electrically controlled in order to meet lighting needs, minimize thermal load on heating and/or cooling systems, provide privacy within interior spaces of buildings and vehicles, or control detriments associated with ultraviolet light exposure.

One type of smart window technology is based on twisted nematic or super twisted nematic liquid crystal technology. However, in such systems, polarizers are required, resulting in high optical loss, as up to 60% of incident light is absorbed by the polarizers in a non-blocking mode of operation.

Another type of smart window technology is based on polymer dispersed liquid crystal technology (PDLC). In general, PDLC technology involves phase separation of nematic liquid crystal from a homogeneous liquid crystal containing a suitable amount of polymer. The phase separation can be realized by polymerization of the polymer. The phase separated nematic liquid crystal forms micro-sized droplets dispersed in the polymer bed. In the off-state, the liquid crystal molecules within the droplets are randomly oriented, resulting in mismatching of the refractive indexes between the polymer bed and the liquid crystal droplets and hence a translucent or light scattering state. When a suitable electric field is applied, the liquid crystal orients such that the refractive indexes between the polymer bed and the liquid crystal droplets are oriented such that a transparent state results. The main disadvantage of the PDLC technology is the inherent haze caused by the optical index mismatching, particularly at large viewing angles.

An attractive panel switching technology is based on polymer stabilized cholesteric texture (PSCT) liquid crystal technology. For a general introduction to PSCT and related polymer-stabilized liquid crystal technologies, see the “Virtual Textbook” at Case Western Reserve's PLC website: http://plc.cwru.edu/tutorial/enhanced/main.htm, which is incorporated herein by reference. PSCT generally may be formed in “normal” mode, “reverse” mode, or bistable mode. In the normal mode, the liquid crystals are in a focal conic state and scatter light. If an electric field is applied to the liquid crystal via a conductive coating, the liquid crystals orient themselves with the electric field and the panel appears transparent. In the power-OFF state, the panel has a frosted or milky appearance and provides privacy. In the power-ON state the panel is transparent.

PCT patent application number U.S. 00/09184 entitled “Electro-Optical Glazing Structures Having Scattering and Transparent Modes of Operation” is incorporated by reference herein and owned by Reveo, Inc., affiliated with the applicants herein, and relates PSCT glazing structures. Kent State University patents relevant to normal mode PSCT include U.S. Pat. No. 5,437,811 entitled “Liquid Crystalline Light Modulating Device and Material”, U.S. Pat. No. 5,691,795 entitled “Polymer Stabilized Liquid Crystalline Light Modulating Device and Material”, and U.S. Pat. No. 5,695,682 entitled “Liquid Crystalline Light Modulating Device and Material”, all of which are incorporated herein by reference. Philips patents relevant to PSCT glazing structures include U.S. Pat. No. 5,188,760 entitled “Liquid Crystalline Material and Display Cell containing said Material”, which is incorporated herein by reference.

“Reverse mode” PSCT is similar to the normal mode PSCT product, but with some key differences. The liquid crystal panel is transparent in the power-OFF state and scattering/opaque in the power-ON state. Further, an additional orientation layer is generally applied to the substrates before lamination of the liquid crystal mixture. During curing of the panel, which is typically slower than for normal mode product, no electric field is applied to the mixture. Also, the formulation is a modified liquid crystal mixture, and includes higher polymer concentration. Reverse mode PSCT are particularly suitable for automotive type applications when a fail-safe state must be transparent. It is also preferred for use when the main duty of the glazing structure is to act as a transparent window.

Kent State patents relevant to reverse mode PSCT include U.S. Pat. No. 5,691,795 entitled “Polymer Stabilized Liquid Crystalline light Modulating Device and Material” and U.S. Pat. No. 5,437,811 entitled “Liquid Crystalline Light Modulating Device and Material”, both of which are incorporated herein by reference.

Bistable PSCT systems operate in a different manner, whereby a voltage need only be applied to switch from a scattering/opaque state to a transparent state, and vice versa. Such systems are desirable due to low energy requirements, as voltage is applied only for switching operations.

Flexible devices formed of polymer stabilized liquid crystals are described in Hakemi et al. U.S. Pat. No. 6,049,366, incorporated by reference herein, and assigned to Sniaricerche S.c.p.A. Described therein are methods, of making flexible films by lamination wherein the polymer stabilized liquid crystals contain microparticles or microspacers (well known in PDLC art). However, while the lamination process is disclosed, no method is taught therein to facilitate exposing the conductive surfaces, cutting the laminate (especially during a web process or a web process having an electric field applied), or forming various shapes.

While these references disclose various materials, structures, and processes useful to preparation of flexible glazing structures, there nonetheless remains a need for improved processing techniques to realize these flexible glazing structures at a commercially feasible cost range. Process improvements are particularly required to increase speed of production of flexible glazing structures. Problems encountered for realizing commercial products include exposing of conductors for electrical connection, cutting laminated structures, particularly when a voltage is required during cutting processes, and cutting and shaping the flexible glazing structures to desired shapes and dimensions. No conventional processing techniques address these problems.

### SUMMARY OF THE INVENTION

The above-discussed and other problems and deficiencies of the prior art are overcome or alleviated by the several methods and apparatus of the present invention for.

The present invention relates generally to solving the above-mentioned problems. Particularly, methods and processes are disclosed that enable fast and efficient cutting and shaping of flexible glazing structures into any desired shape and size.

In certain embodiments, methods and processes are disclosed whereby barrier lines are formed to define regular or irregular cutting lines and seals.

In certain embodiments, methods and processes are disclosed whereby notches are defined to expose upper and lower substrate conductive surfaces.

In certain embodiments, methods and processes are disclosed whereby glazing structures of irregular shapes and sizes are formed.

The above-discussed and other features and advantages of the present invention will be appreciated and understood by those skilled in the art from the following detailed description and drawings.

### BRIEF DESCRIPTION OF THE FIGURES

For a more complete understanding of the present invention, the following Detailed Description of the Invention should be read in conjunction with the following Drawings, wherein:

FIG. 1 shows a general embodiment of steps to fabricate flexible glazing panels;

FIG. 2 shows an end view of a pair of substrates illustrating exposed conductor layers;

FIG. 3A shows a top view of a lower substrate including a barrier line according to the present invention;

FIG. 3B shows both substrates having a barrier line therebetween defining a line to cut the glazing structure;

FIG. 4A shows a lower substrate in a process step for forming a custom shaped glazing structure;

FIG. 4B shows an upper substrate in a process step for forming a custom shaped glazing structure;

FIG. 5 shows both substrates laminated and ready to form into a custom shaped glazing structure;

FIG. 6A shows a first step for exposing conductors in a glazing structure according to the present invention;

FIG. 6B shows a structure resulting from the first step of FIG. 6A;

FIG. 6C shows a second step for exposing conductors in a glazing structure according to the present invention;

FIG. 6D shows a structure resulting from the steps of FIGS. 6A and 6C;

FIG. 7 shows a method of making a shape having a width substantially equivalent to that of the web;

FIG. 8 shows one method of making an irregular shape with non-standard width;

FIG. 9 shows another method of making an irregular shape with non-standard width

### DETAILED DESCRIPTION OF THE INVENTION

Herein disclosed is a method of manufacturing flexible glazing structures, and more generally a method of manufacturing flexible liquid crystal cells. The structures formed according to the present invention may be useful as laminates upon conventional windows or glass substrates, stand alone glazing structures (e.g., wherein some degree of flexibility of the glazing structure is desirable, as in eyeglasses or face shields), or flexible displays. The structure may be retrofitted on existing interior and exterior architectural glazings, automotive windows, and other interior glazings. A transparent adhesive may be used to stick the panel to the window, which may be integral with the panel or separately provided. The panel may also be applied to original windows before installation. Many applications of the structure formed according to the present invention will be apparent to one skilled in the art.

The embodiments herein may be applicable to most type of liquid crystal cells, and in particular to PSCT based liquid crystal cells, including normal-mode, reverse-mode and bistable-mode.

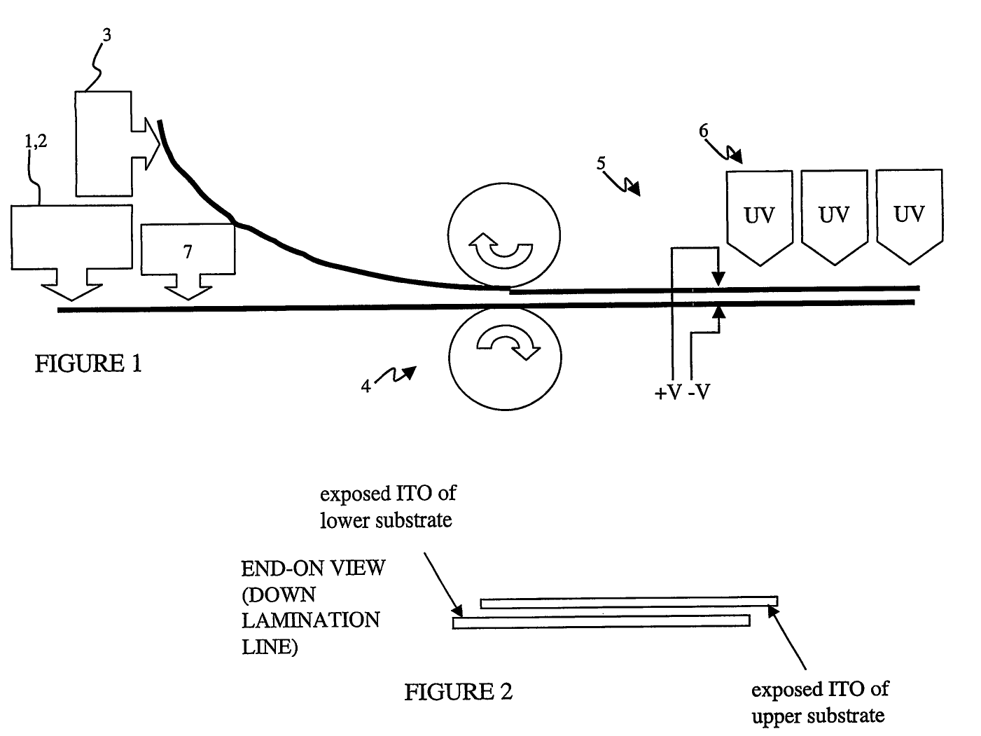

In general, and referring to FIG. 1, the process steps to make flexible liquid crystal cells panels are as follows:
(1) Mix (1) together a liquid crystal formulation;
(2) Coat (2) the formulation onto a conductively coated, flexible substrate;
(3) Apply spacer particles (3) to the liquid crystal material on the substrate, and optionally, apply adhesive (7), preferably a transparent adhesive, between on the substrate;
(4) Laminate the substrates together (e.g., with rollers 4) to sandwich the liquid crystal and spacers between the substrates;
(5) Apply an electric field (5) to the liquid crystal (using the conductive surfaces);
(6) Cure (6) the prepolymer using UV radiation to form a polymer stabilized liquid crystal.

Application of the electric field and curing may occur simultaneously to achieve the desired properties of the liquid crystal material, i.e., to form a polymer network to stabilize the liquid crystals in a focal conic state.

In certain preferred embodiments, materials are selected to allow room temperature coating, lamination or both.

The substrates may be the same or different, and may be selected from the group consisting of plastics of plastic-on-glass, as are known to those skilled on the art of flexible LCDs. Suitable substrates include polyethyleneterephthalate (PET), polybutyleneterphthalate, polyether sulfones (PES), polyamides, polycarbonates, and polypropylene.

An electrode layer is formed on each cell. In certain embodiments, the electrode layer is formed on the substrate prior use in the glazing structure fabrication process. However, it is understood that the electrode layer may be applied in the same fabrication process at a preceding step. The electrodes may be the same or different, and may be selected from the group consisting of tin oxides, indium tin oxide (ITO), thin films of other high conductivity metals such as gold, titanium or the like, or electrically conductive polymers. The electrodes may be formed on the substrates by any conventional techniques, such as sputtering, electron-beam vacuum deposition, ion-plating, chemical vapor deposition, or other, coating techniques.

The form and dimensions of the substrates may be selected based on the desired properties of the glazing structure (e.g., desired transparency and flexibility, ambient operating conditions, desired voltage). Generally, the form and dimensions are suitable for laminating and cutting as described herein. The substrates may be in the form of sheets, plates, or film. Films are generally preferred as they may be readily dispensed and handled on a web process on rolls. The thickness of such substrates are not limited, but are generally about 20 μm to about 1000 μm. In certain embodiments, the substrate may be pre-treated with a solvent wipe or buffing step.

Thus, in certain preferred embodiments, the conductive substrates comprise commercially available ITO) coated PET. In other preferred embodiments, the conductive substrates comprise a conductive polymeric coating on PET (e.g., as available from Agfa and Avery Dennison). In most preferred embodiments, the PET thickness is about 4 mil to about 7 mil (about 100 μm to about 175 μM).

Also, as described generally above, spacer particles (3) may be employed. Such particles may be any dimension as in known in the art to impart the desired cell spacing between substrates for liquid crystal material. The spacer particles may be any form or material that is compatible with the system. Such spacer particles may alternatively, or in conjunction with discrete application, be mixed with the liquid crystal formulation before the coating step. In certain preferred embodiments the spacer particles comprise glass beads or glass rods having diameters of about 20 μm to about 30 μm).

Typically, the substrate edges are wiped clean and sealed with adhesive prior to application of electrical contacts to the conductive coatings on the exposed substrate surfaces.

The liquid crystal formulation generally comprises chiral and/or nematic liquid crystal material; a prepolymer material, preferably non-mesogenic, organic monomers, in a quantity of about 1% to about 8% by weight, preferably about 2% to about 4% by weight; photoinitiator material. Optionally, dyes and other additives may be included for color (dichroic dyes are preferred). Not intending to be limiting, the aforementioned PCT patent application number U.S. 00/09184, and U.S. Pat. Nos. 5,437,811, 5,691,795, 5,695,682,5,188,760, 6,049,366, all of which are incorporated by reference herein, describe various PSCT compositions that may be used to fabricate cells that will benefit from the methods of the present invention.

The above described process for forming flexible glazing structures generally results in continuous ribbons of laminate of fixed width, the web width. This continuous ribbon must be cut into shorter lengths and sealed. It would be desirable to provide such a process wherein shapes may be pre-formed in the web, particularly to complement the need for a wider range of product sizes and shapes. This process preferably enables high line speeds, a range of shapes and sizes, and low cost production.

Obstacles to overcome in order to provide such a process include:
conductive coatings on the inner surfaces of substrates is exposed in the final panel, to allow for contact with electrical wiring
prevention of physical contact between conductive coatings on facing substrates (such contact would result in an electrical short and damage to the glazing structure).
uniformity of liquid crystal formulation layer thickness, to prevent a non-uniform appearance due to thickness variations in local areas.

Referring now to FIG. 2, one method to expose the conductive coating (e.g. ITO) on the inner surface of the substrates in the flexible glazing structures is to offset the upper and lower substrates. In this manner, the conductive coatings on the inner surfaces are exposed during and after curing, facilitating electrical connection.

In one example, the glazing structure, once coated, laminated and cured, can be cut with scissors and subsequently sealed after cutting without damage to the panel. The spacer and liquid crystal formulation tend to open the cut edges apart after cutting is complete. The open edge can then be sealed with adhesive. For example, the edge may be dipped in adhesive, adhesive tape may be applied to edges, or other known sealing technique may be employed.

However, if the cutting step is carried out in the above-described process when an electric field is applied to the panel, the two substrates may likely short as they are pressed together during cutting.

Further embodiments describe methods to eliminate shorting during the cutting step, even if the cutting is performed with an applied electric field (e.g., with an electrically insulated cutting tool). In certain embodiments, the laminate is cut after the liquid crystal material is cured. In further embodiments, the laminate is cut before the liquid crystal material is cured or applied.

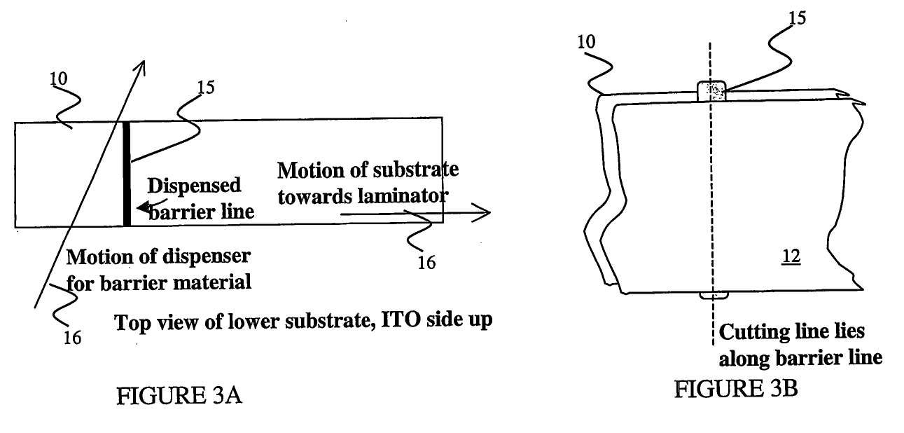

Referring to FIGS. 3A and 3B, a preferred method to facilitated cutting is described. Strips of glue or other non-conductive barrier material are applied to one conductive substrate before coating with liquid crystal material and before curing. The material may any suitable non-conductive material that will function as a barrier for (i) facilitating cutting and (ii) providing a sealed edge to the glazing structure. The material may be solid, polymerizable, or in the form of a tape, for example. The material may be applied by dispending, printing, brushing, or other suitable deposition methods. Suitable materials include, but are not limited to, polyurethane, UV curable optical adhesion glues (e.g., NOA 91 available from Norland Products). Preferably, the material is selected to be compatible with screen printing techniques.

In one embodiment, as shown in FIG. 3A, a conductive substrate 10 (a lower substrate as described herein, although it is understood that the references to “lower” and “upper” are relative and used for convenience only) as is provided on a mechanism (not shown) such that the conductive substrate 10 is traversing in a direction indicated by an arrow 16 towards a laminator. In general, the conductive coating is on the surface of the substrate 10, and a dispenser (not shown) is used to scan across (in the direction indicated by the arrow 13) the conductive substrate 10 and deposit a barrier line 15.

After coating with liquid crystal material, laminating the second conductive substrate 12, and curing, the laminate can be cut along the barrier line 15, shown in FIG. 3B, leaving some barrier material on either side of the cut for an edge seal of the glazing structure. The barrier material may provide a sufficient seal for the cut edge, or the edge seal may optionally be enhanced with additional adhesive, such as adhesive tape or an additional curable adhesive materiel.

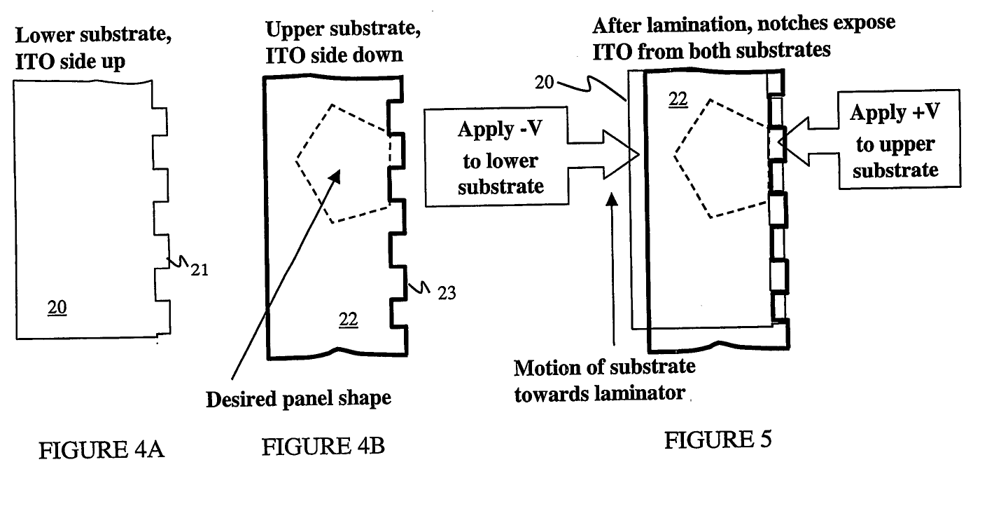

In further embodiments, challenges are overcome to cut the glazing structure to custom shapes. To achieve non-standard widths, i.e., widths less than the web width, a key obstacle is to provide access to electrical contact areas on both substrates. As shown in FIGS. 4A and 4B, a method to overcome this obstacle is described. A notch 21 is cut in the lower conductive substrate 20, and a notch 23 is cut in the upper conductive substrate 22. The notches may be formed by any suitable means, such as die cutting. The upper and lower substrates are registered such that the notches do not overlap when the substrates are laminated together. Further, the substrates are offset, such that (as shown in FIG. 5) the lower conductive substrate 20 extends beyond the upper conductive substrate 22.

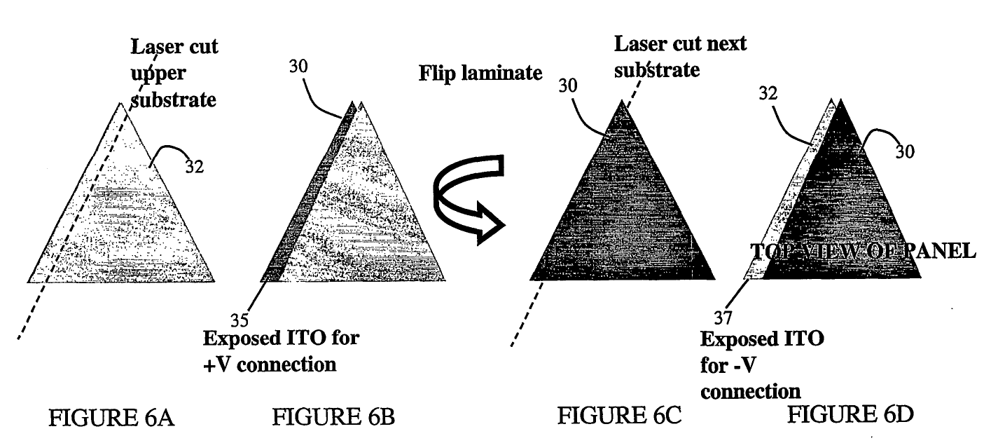

Another techniques for creating custom shapes generally results in a panel that can be switched by connecting the positive terminal of the driver to an exposed notch on the upper substrates and the negative terminal to a notch on the lower substrate. For example, the barrier method shown with respect to FIGS. 3A and 3B is employed to trace out the desired shape on one substrate before lamination. After lamination, the desired shape is cut through the barrier lines. As shown in FIG. 6A, using a laser cutting or other tool, the upper (first) conductive substrate 32 of the shaped panel is cut away to expose the lower conductive substrate 30 along one edge of the shape. Cutting or damage through the lower conductive substrate or damage the ITO coating on the exposed portion 35 of the lower conductive substrate is avoided (FIG. 6B). The shape is then flipped (FIG. 6C) and the second substrate 32 is cut away (FIG. 6D) to expose a portion 37 of the first conductive substrate 32 along another edge. For optimal panel performance, the exposed ITO areas 35, 37 are cleaned of liquid crystal residue before connections are made.

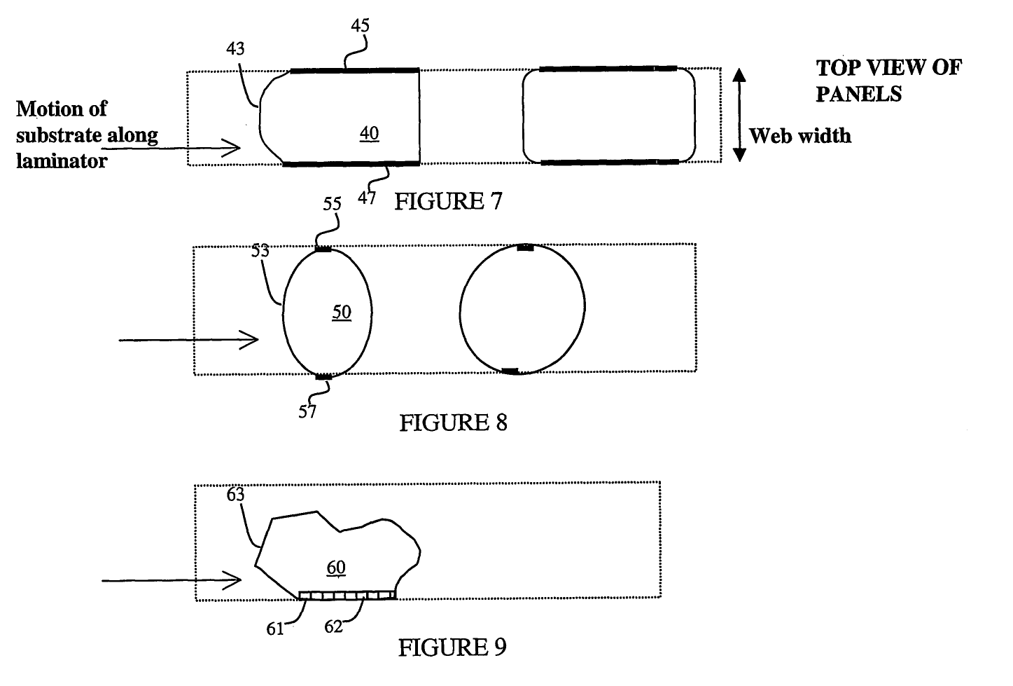

Referring now to FIG. 7, a method to produce non-rectangular shapes 40 with standard widths is shown. The offset technique described herein may be combined with the barrier method described herein. As shown in FIG. 7 (top view), the offset edges 45, 47 are provided, e.g., during lamination, or optionally as described above with respect to FIGS. 6A-6D. As the glazing structure width is the web width, no further cutting is required. The irregular edge is defined with a barrier edges 43, which may be cut to leave behind sealed edges as described above with respect to FIGS. 3A and 3B.

Referring now to FIG. 8, a method to produce non-rectangular shapes 50 with non-standard widths is shown. The offset technique may be combined with the barrier method. As shown in FIG. 8, the offset edges 55, 57 are provided at the web edges. Note these are considerably smaller than the offset edges in FIG. 7 for a standard width shape. The barrier edges 53 defines an irregular edge, which may be cut to leave behind sealed edges as described above with respect to FIGS. 3A and 3B.

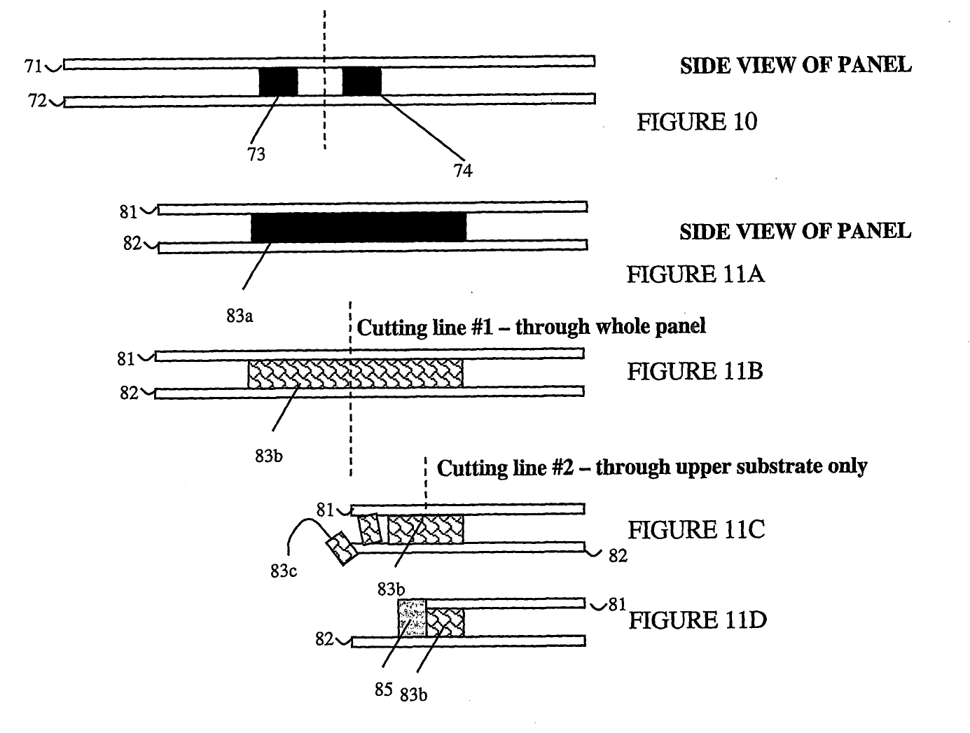

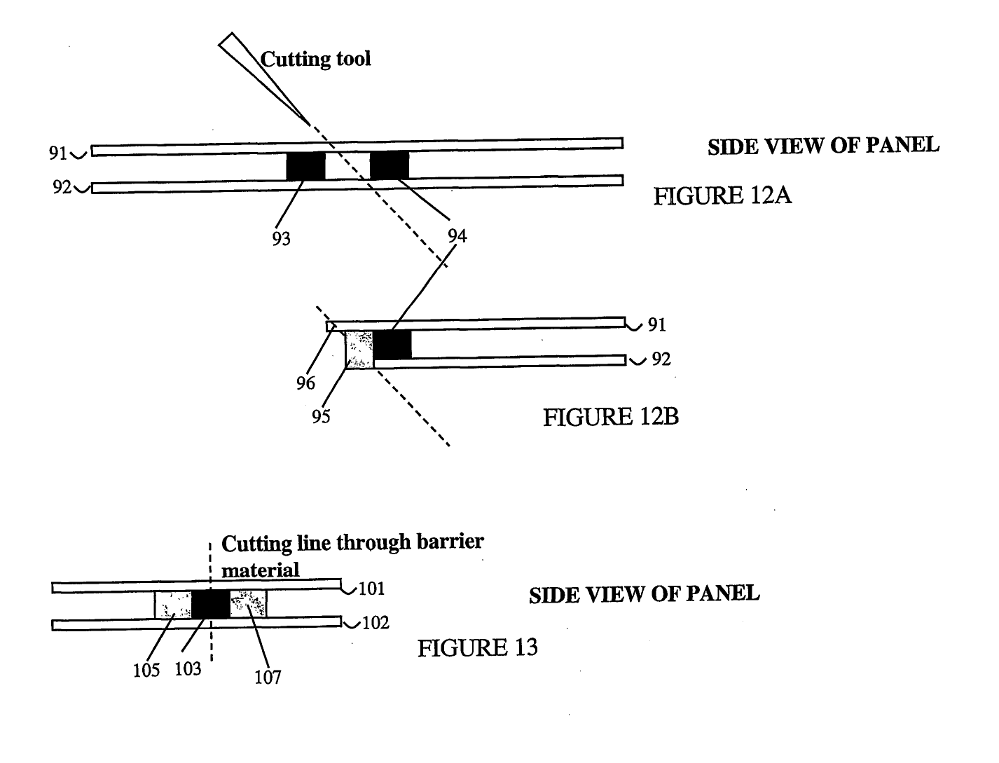

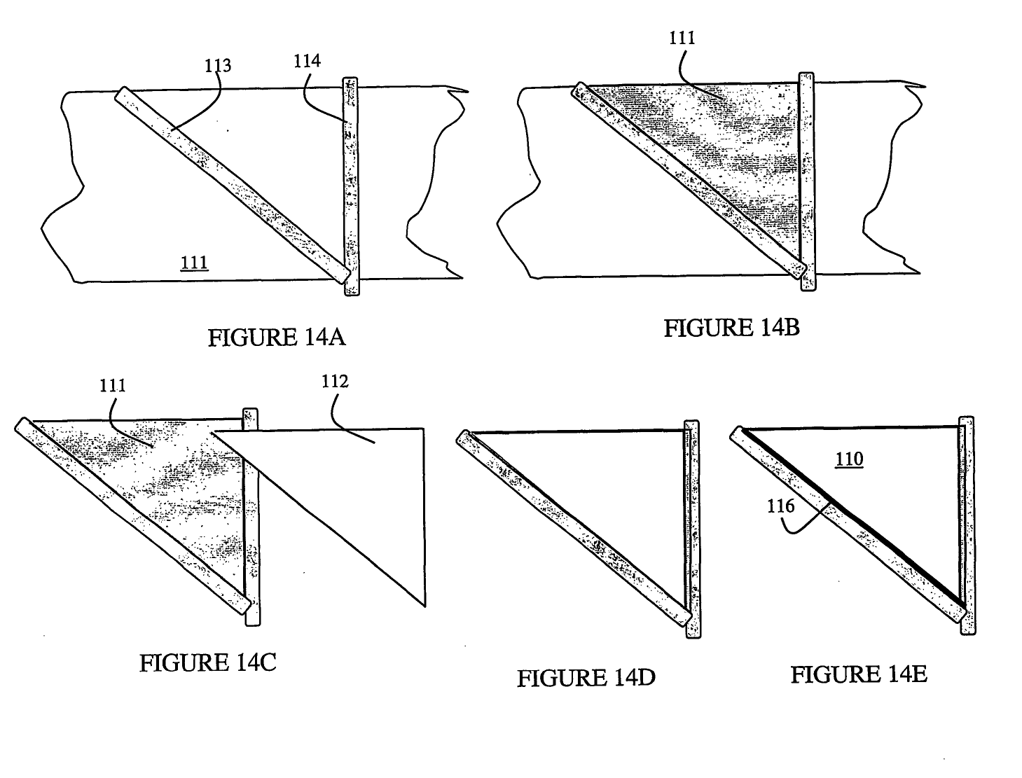

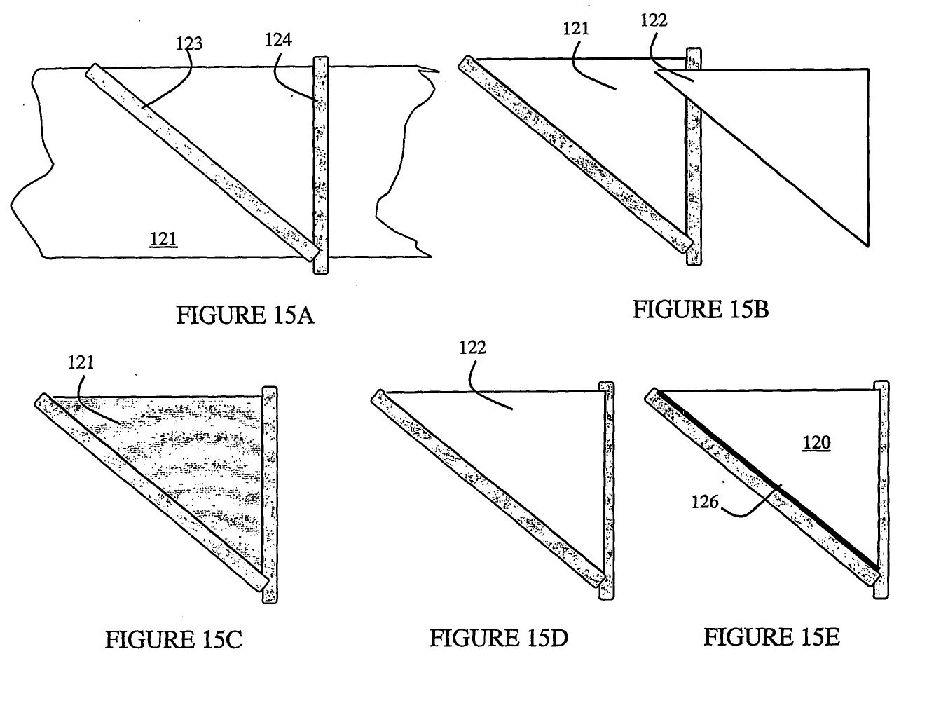

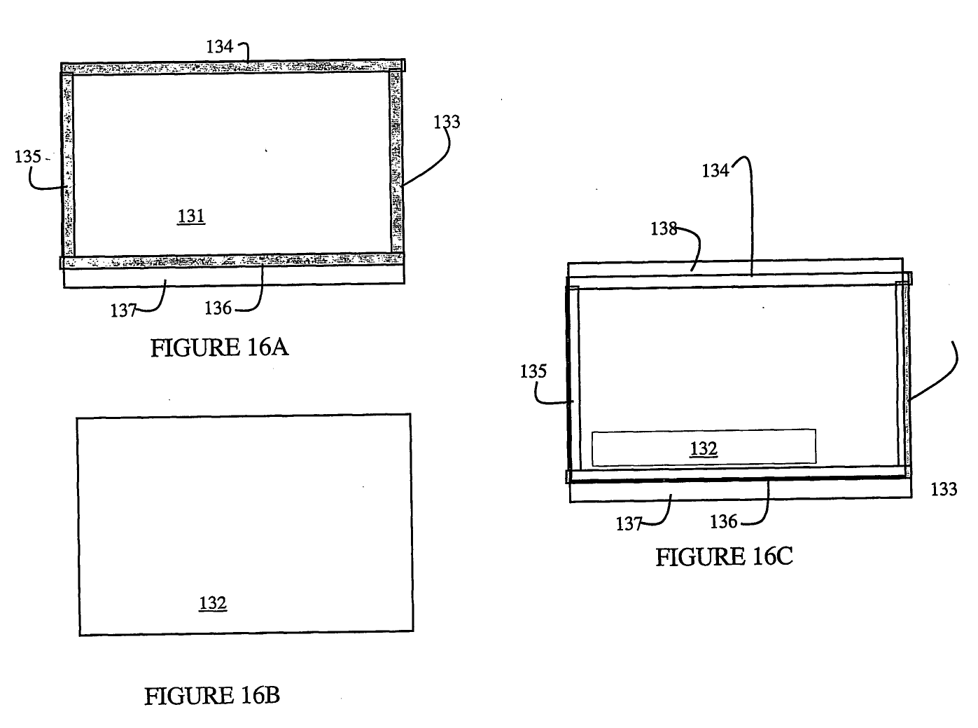

FIG. 9 shows a method to produce non-rectangular shapes 60 with non-standard widths. The notch technique, described above with respect to FIGS. 4A, 4B and 5, may be combined with the barrier method, as shown. Notches 61 and 62 associated with upper and lower substrates, respectively (or vice versa) are defined to expose conductors for the substrates. The barrier edges 63 defines an irregular edge, which may be cut to leave behind sealed edges.

An alternative method to shear panels from a continuous web may be without adhesive or barrier materials prior to lamination. After lamination, the desired panel shape is cut out. This cutting step may require cooling or a special cutting technique to eliminate electrical shorting. The upper and lower substrates are sheared to create an offset area, as shown in FIGS. 6A-6D. The offset area is cleaned, all edges are sealed, electrical contacts are applied to the offset area. The panel including the liquid crystal material is then allowed to cure.

Referring to FIG. 10, a side view of a panel is shown, depicting another shearing method. Non-adhesive barrier material 73, 74 is applied generally along the desired panel edge lines prior to lamination. The barrier material preferably adheres to only one substrate, such that the upper and lower conductive substrates 71, 72 do not stick together. For example, uncured adhesive barrier material 73, 74 may be applied to the lower conductive substrate 72 and fully cured before the upper conductive substrate 71 is coated over it The barrier material can be applied as a single line 73 or 74, or as two parallel lines 73 and 74 as shown in FIG. 10. After lamination, the panel shape is cut out along a single barrier lines or between double barrier lines 73, 74. The upper and lower conductive substrates 71, 72 are sheared to create an offset area. Generally, the shear distance should be sufficient to expose uncoated conductive areas on both substrates. Optimally, exposed offset areas are cleaned, exposed barrier material is removed if needed, all edges are sealed, and electrical contacts to are applied to offset areas. The panel including the liquid crystal material is then allowed to cure.

Referring now to FIGS. 11A-11D, another method to cut flexible glazing panels including conductive substrates 81, 82 having liquid crystal material therebetween is shown. In general, as shown in FIG. 11A, a barrier 83a is formed along a cut line for the desired panel shape. Instead of (or in addition to) using an adhesive as the barrier material, a barrier material is used that is friable or can be made brittle or friable upon heating and/or UV curing. The substrates 81, 82 are laminated, and the liquid crystal material is cured. As shown in FIG. 11B, the panel is cut along the lines of the brittle barrier material 83b. Then, as shown in FIG. 11C, the upper substrate 81 is cut along one edge. Exposed brittle barrier material 83c is removed at the panel edge. Referring to FIG. 11D, an adhesive seal 85 may be applied, and electrical contacts applied to offset areas (not shown). Optimally, exposed contact areas are cleaned prior to applying contacts and optionally sealing.

Referring to FIGS. 12A and 12B, another method for cutting a panel including conductive substrates 91, 92 edges is shown. This method is particularly suitable for thicker laminates. Generally, the panel edges are slant-cut. Prior to lamination, adhesive/barrier material 93, 94 is applied in parallel lines around desired panel shape. After lamination and curing of substrates 91, 92 having liquid crystal material therebetween, the panel is cut on a slant, using a slanted cutting tool or cutting on a slant angle. Note that edges of substrates 91, 92 not to be used for electrical contact may be cut using a conventional cutting tool. Optional additional adhesive 95 may be applied to the cut edges. Optimally, exposed conductor areas 96 are cleaned and electrical contacts are applied.

In a further method, a portion of the operation may occur at low temperatures. By temporarily increasing the rigidity of the liquid crystal layer during cutting, the likelihood of electrical shorting may be reduced. The laminate is frozen or cooled such that the viscosity of the liquid crystal material is increased. Thus, the laminate may be cut without the two conductive (e.g., ITO) layers contacting each other.

In another method, and referring now to FIG. 13, “expansion joint” edges may be included between conductive substrates 101, 102 having liquid crystal material therebetween. Such edges can reduce cracking of the adhesive seal during cutting. For example, if the adhesive used to seal the perimeter of a custom-shaped panel is rigid or brittle, it may be damaged or crack during cutting. To reduce this potential damage, before lamination, lines of adhesive 105, 107 and a line of barrier material 103 is dispensed along the perimeter of the desired panel shape, to create an alternating line structure. The barrier material 103 can be a material that decomposes or becomes brittle when cured or exposed to subsequent processing steps, or can be a material chosen for its ability to cut cleanly and offer additional protection to the adhesive seals 105, 107 or both 105 and 107. After lamination and curing, the panel is cut along the line of barrier material. In preferred embodiments, the cut edges will not require additional sealing, since the adhesive lines 105, 107 preferably remains intact after barrier 103 is cut. The remaining barrier material can either be removed (without inducing contact between the conductive coatings on facing substrates), or retained to prevent shorting and protect the adhesive seals 105, 107 or both 105 and 107. Note that with this method, the edges of two separate panels may be facilitated with one cut.

In a further embodiment, and referring now to FIGS. 14A-14E, another method of forming shaped electrically switchable panel or glazing structure 110 is provided, generally wherein the layers are cut prior to lamination and curing. FIG. 14A shows adhesive or barrier material 113, 114 dispensed on a first conductive substrate 111, for defining the shape. FIG. 14B shows liquid crystal material coated on the first conductive substrate 111 (alternatively, the liquid crystal material may be coated on the second substrate). Separately, the first and second conductive substrates 111 and 112 are cut as shown in FIG. 14C. Note that cutting may be by stamp cutting, blade cutting, laser cutting, or any other suitable method. FIG. 14D shows both cut conductive substrates 111, 112 laminated together. FIG. 14E shows that the a portion of the second conductive substrate 112 is sheared to expose an area 116 of the inner conductive coating of the substrate. Finally, the exposed edge 116 may be cleaned, and the laminate cured. A second conductive area may be formed, e.g., as described with respect to FIGS. 6A-6D.

In a further embodiment, and referring now to FIGS. 15A-15E, another method of forming shaped electrically switchable panel or glazing structure 120 is provided, generally wherein the layers are cut prior to lamination and curing. FIG. 15A shows adhesive or barrier material 123, 124 dispensed to a first conductive substrate 121. FIG. 15B shows that both conductive substrates 121, 122 have been cut into the desired shape, e.g., by stamp cutting, blade cutting, laser cutting, or the like. FIG. 15C shows that liquid crystal material is coated on the first cut substrate 121 (alternatively, liquid crystal may be coated on the second cut substrate). The cut substrates 121, 122 are then laminated together, shown in FIG. 15D. Then, an edge of one of the substrates 121 is sheared to expose a small area 126 of inner conductive coating. Finally, the exposed edge may be cleaned, and the laminate cured. A second conductive area may be formed, e.g., as described with respect to FIGS. 6A-6D.

Referring now to FIGS. 16A-16C, another method of forming a shaped electrically switchable panel or glazing structure 130 is provided, generally wherein the layers are cut prior to lamination and curing. A lower substrate 131 is provided, cut to a desired shape. As shown, barrier material is provided in strips 133, 134, 135, and 136. Note that strip 136 is set back from the edge of the conductive substrate 131. This exposes a conductive region 137. The upper substrate 132 (FIG. 16B) is slightly smaller that the lower substrate 131, allowing the edges to be disposed on top of the barrier lines 133-136. The upper substrate is positioned offset to allow exposure of a conductive region 138 of the upper conductive substrate 132.

While preferred embodiments have been shown and described, various modifications and substitutions may be made thereto without departing from the spirit and scope of the invention. Accordingly, it is to be understood that the present invention has been described by way of illustrations and not limitation.

1. A method to expose a conductive coating on an inner surface of a substrate in a flexible glazing structures including a pair of substrates, comprising offsetting the substrates such that the conductive coatings on at least one inner surfaces is exposed during and after curing.

2. A method of cutting flexible glazing structures comprising:
applying a non-conductive barrier material to a first of a pair of substrates to be laminated before coating with liquid crystal material;
laminating the pair of substrates with liquid crystal material therebetween; and
cutting the laminate along the barrier lines.

3. A method to expose electrical contacts in flexible glazing structures comprising:
cutting notches in both of a pair of substrates to be laminated;
registering the substrates such that the notches do not overlap when the substrates are laminated together.

4. A method of cutting flexible glazing structures as in claim 2 further comprising:
shearing the first substrate to expose the second substrate along one edge of cut shape; and
shearing the second substrate to expose the first substrate along another edge of cut shape.

5. A method of cutting flexible glazing structures comprising:
laminating a pair of substrates having liquid crystal material therebetween;
lowering the temperature of the substrates and liquid crystal material to a temperature sufficiently low to increase the viscosity of the liquid crystal material; and
cutting the laminate, whereby due to the high viscosity, the substrates to not contact one another.

6. A method of forming shaped glazing structures comprising:
applying barrier material to a first substrate for defining a shape;
coating liquid crystal material on the first or a second substrate;
cutting the first and second substrates;
laminating the cut substrates together;
shearing a portion of one of the substrates to expose an area of an inner conductive coating of the substrate; and
curing the laminate.

7. (canceled)

8. A method of forming shaped glazing structures as in claim 6, wherein coating is performed prior to cutting.

9. A method of forming shaped glazing structures as in claim 6, wherein cutting is performed prior to coating.
